(19) United States
(12) Patent Application Publication
(10) Pub. No.: US 2007/0218984 A1
(43) Pub. Date: Sep. 20, 2007

(54) A MULTI GAME SYSTEM IN A COMMUNITY, AND A METHOD THEREOF

(75) Inventor: Zoo Il Yang, Uiwang-city (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/568,392

(22) PCT Filed: Apr. 20, 2005
(86) PCT No.: PCT/KR05/01132

§ 371 Date: Oct. 26, 2006

(30) Foreign Application Priority Data
Apr. 29, 2004 (KR) 10-2004-0029790

(51) Int. Cl. A63F 13/12; G06F 17/00

(52) U.S. Cl. 463/29; 463/42

(57) ABSTRACT

Disclosed is a system and method for a multi-user game in a community such as a cafe, a homepage, a blog, a miniroom, or a mini-homepage and the like, which are established in web sites on the Internet. The method for a multi-user game in a community includes a) a plurality of community visitors accessing the community established on a website; b) a plurality of community visitors selecting a multi-user game program prepared in the community, and executing the multi-user game program; c) confirming whether the community visitors execute or terminate the multi-user game program; d) receiving the plurality of visitor-related data related to the execution of the multi-user game program when the multi-user game program is terminated; and e) processing and storing the plurality of visitor-related data in the community. According to the present invention, it is possible to attract participation of a large number of visitors in the community by providing dynamic community participation contents.

### TECHNICAL FIELD

The present invention relates to a system and method for multi-user games in a community, and more particularly, to a system and method for multi-user games in a community such as a cafe, a homepage, a blog, a miniroom, or a mini-homepage and the like, which are established in websites or on the Internet.

### BACKGROUND ART

At present, various websites exist that are providing Internet community services in the country. In these Internet community sites, a community operator can establish a community by applying for the community to a relevant Internet service provider, and users can be members of the community by subscribing to the community. The community operator and members compose one community.

In current Internet community services, one community continues to exist, in principle, as an individual, which is separate from other communities. Optionally, it could be designed to allow communities to share information according to operation methods of the Internet Service Providers.

On the other hand, in the current Internet community services, horizontal movement from one community to another community is possible, and each of Internet communities which are running at present includes one or more public or private bulletin boards.

Also, in a case of a variety of online games with several million users and with several hundred thousand simultaneously connecting users, a plurality of small and medium communities called clans or guilds are organized. These communities are composed of users who enjoy the same games. These users often do energetic activities online or offline, such as studies and discussions on various game tactics, play of games in combination for missions, and the like.

FIG. 1 is a schematic diagram illustrating configuration of a conventional community on an Internet network.

Referring to FIG. 1, the conventional community can be implemented with a plurality of websites 120, 130, and 140 and an individual community 150 and the like, all of which are connected through the Internet 110. The plurality of websites 120, 130, and 140 include first to N-th communities 131, 132, and 133, respectively. In this case, each of first to the N-th communities 131, 132, and 133 may include a blog 161, a miniroom 162, a mini-homepage 163, and the like.

FIG. 2 is a diagram illustrating an example of a conventional website having a community and a contents server. A conventional website 210 can include a community 211 accessed by a plurality of clients 221, 222, and 223, and a contents server 212 providing a plurality of contents to the community 211.

Referring to FIG. 2, in the conventional website 210 having the community and the contents server, when the plurality of clients 221, 222, and 223 access the community 211 and then select a link program in the community 211, they are connected to a website 230 actually having the link program. The website 230 manages game scores made by the plurality of clients 221, 222, and 223, for example, when the plurality of clients 221, 222, and 223 execute a game program. Also, if the link program is provided from the contents server 212 on a web browser of the community 211, the website 210 having the contents server 212 manages data related to the plurality of clients 221, 222, and 223. In other words, the community 211 only plays a role of connection to the link program, and substantial execution of the link program and management of the data are performed by the websites providing the link program.

On the other hand, the blog, which is an abbreviation of web log, refers to a new form of web service having complex functions of a web bulletin board, individual homepages, and communities. Typically, the blog service is a service provided to solve problems such as anonymity, unidirectionality, low contents notice rate and the like, which are disadvantages of conventional Internet bulletin boards. It means a kind of individual media community having an exclusive area assigned on a network by using simple text or graphics. That is, since the blog service can obtain the effect of security and confidentiality of an individual homepage while providing service subscribers with a simple creation technique that does not require knowledge related to use of an existing homepage creation program and Internet homepage creation, it is an actual circumstance in which the range of users has been rapidly expanded.

More particularly, it is known that John Barger first used the term web log in November of 1997, and the term log has a meaning of logbook or travel diary. A blog, which is a site for blogging, the word having been invented by Evan Williams, is defined as a web page consisting of short sentences which are updated periodically, like a diary. Thus, anyone can set up such a blog in their own web site and download and use a blog program without fee if the blogger has server space in which the blog program can be installed. Also, the blog is free of charge and is easy to handle, and, once it is set on a website, a user can always publish his sentences on-line whenever he wishes to write the sentences.

Up-to-date netizens have used individual homepages to let their existences or opinions be known on-line. To this end, however, they should be able to handle webpage creation tools such as Namo WebEditor and the like and may also have many difficulties in management, such as updates and the like, of the individual homepages. On the contrary, as mentioned above, the blog is free of charge and is easy to handle, and, once it is set on a website, a user can easily enter his sentences online, allowing anyone to have easy access to the blog.

Recently, the portal site Naver (www.naver.com) started providing a service cafeiN, and naver cafe has three hundred thousand associations of like-minded persons, and two thousand associations of like-minded persons are being newly established on average per day. The portal site, Naver, interlinks two services, that is, a service allowing a visitor to leave a sentence in a cafe and another service allowing the sentence and its source to be noticed in the vinstalled in a blogisitor's blog.

### DISCLOSURE OF INVENTION

### Technical Problem

On the other hand, in a community, e.g., a blog that is an individual community, a host desires to please visitors and feels enjoyment from visitor's feedback. In this connection, conventional blogs have problems in that items attracting strangers visits and causing enjoyment are standardized, so interaction between communities is restricted, and moreover, the blogs are plain since the first consideration is given to text messages.

Also, a game program prepared in a community according to the conventional art has a problem in that a plurality of visitors cannot take part in a game.

### TECHNICAL SOLUTION

In order to resolve the above-mentioned problems, it is an object of the present invention to provide a system and method for multi-user games in a community that is capable of attracting participation of a large number of visitors in the community by providing dynamic community participation contents.

It is another object of the present invention to provide a system and method for multi-user games in a community in which contents are easily distributed basically by being loaded on a web browser without a separate installation process.

It is yet another object of the present invention to provide a system and method for multi-user games in a community which is capable of providing services specialized by blog items and creating customized services.

### ADVANTAGEOUS EFFECTS

According to the present invention, it is capable of attracting participation of a large number of visitors in the community by providing dynamic community participation contents.

### BRIEF DESCRIPTION OF THE DRAWINGS

FIG. 1 is a schematic diagram illustrating a configuration of a conventional community on an Internet network;

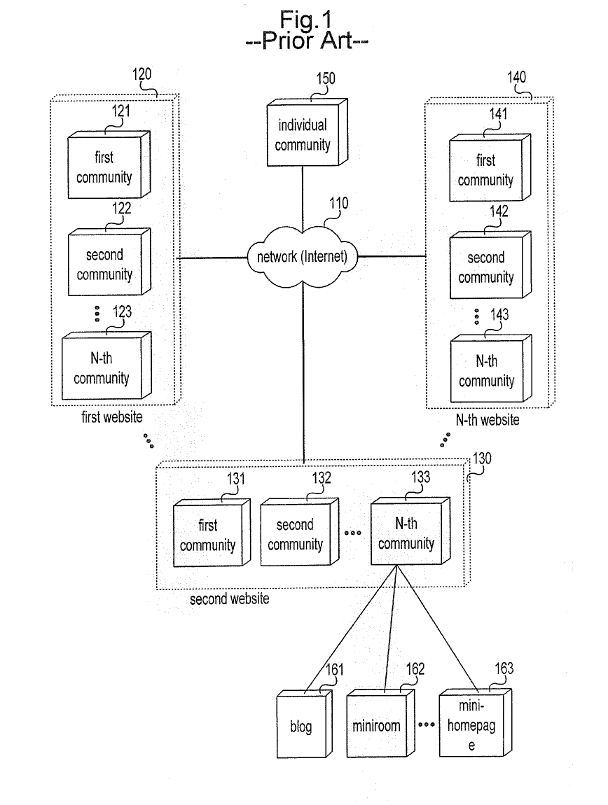

FIG. 2 is a diagram illustrating an example of a conventional website having a community and a contents server;

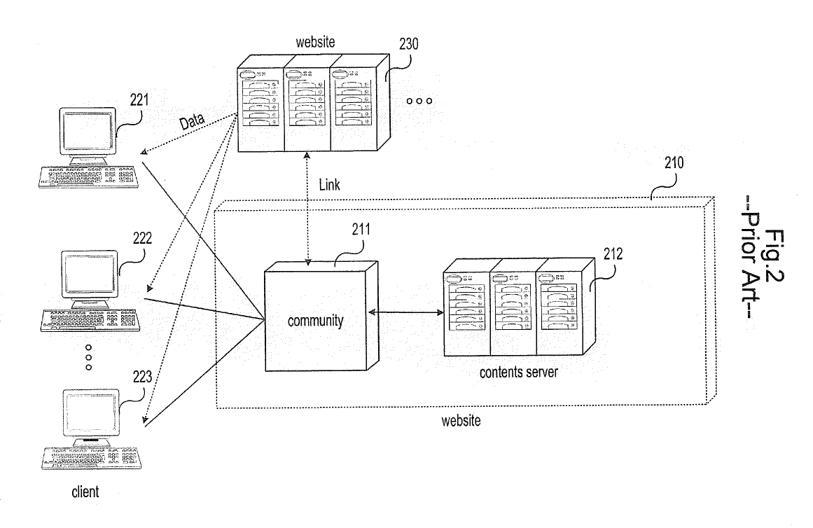

FIG. 3 is a diagram illustrating an example of a conventional website having a community and a contents server according to an embodiment of the present invention;

FIG. 4 is a diagram illustrating a multi-user game in a community according to an embodiment of the present invention;

FIG. 5 is a schematic diagram illustrating a configuration of a multi-user game system in a community according to an embodiment of the present invention;

FIG. 6 is a flow chart illustrating a method for a multi-user game in a community according to an embodiment of the present invention;

FIG. 7 is a diagram illustrating a method for multi-user games in a flash game-linked blog according to an exemplary embodiment of the present invention;

FIG. 8 is a flow chart illustrating a method for multi-user games in a flash game-linked blog according to an exemplary embodiment of the present invention; and

FIG. 9 is a diagram illustrating an example of a flash game-linked blog in which a multi-user game is executed, according to an exemplary embodiment of the present invention.

### BEST MODE FOR CARRYING OUT THE INVENTION

To achieve the above objects, according to an aspect of the present invention, the present invention provides a multi-user game method in a community, the method comprising a) a plurality of community visitors accessing the community established on a website; b) a plurality of community visitors selecting a multi-user game program prepared in the community, and executing the multi-user game program; c) confirming whether the community visitors execute or terminate the multi-user game program; d) receiving visitor-related data related to the execution of the multi-user game program when the multi-user game program is terminated; and e) processing and storing the visitor-related data in the community.

Preferably, the method further includes f) displaying the processed and stored visitor-related data in the community.

According to yet another aspect, the present invention provides a system for multi-user games in a community, the system comprising a connector for determining whether or not a plurality of visitors are permitted to access the community established on a website; a multi-user game controller for allowing the plurality of visitors accessing the community to select a multi-user game program prepared in the community and receiving visitor-related data from the website providing the multi-user game program; a data processor for processing the plurality of visitor-related data such that the plurality of visitor-related data are utilized in the community; and a data storage unit for storing the processed visitor-related data.

Preferably, the multi-user game controller causes the multi-user game program to be interworked to the plurality of visitors such that the plurality of visitors participate in the multi-user game program simultaneously.

### MODE FOR THE INVENTION

Hereinafter, a system and method for a multi-user game in a community according to exemplary embodiments of the present invention will be described in detail with reference to the accompanying drawings.

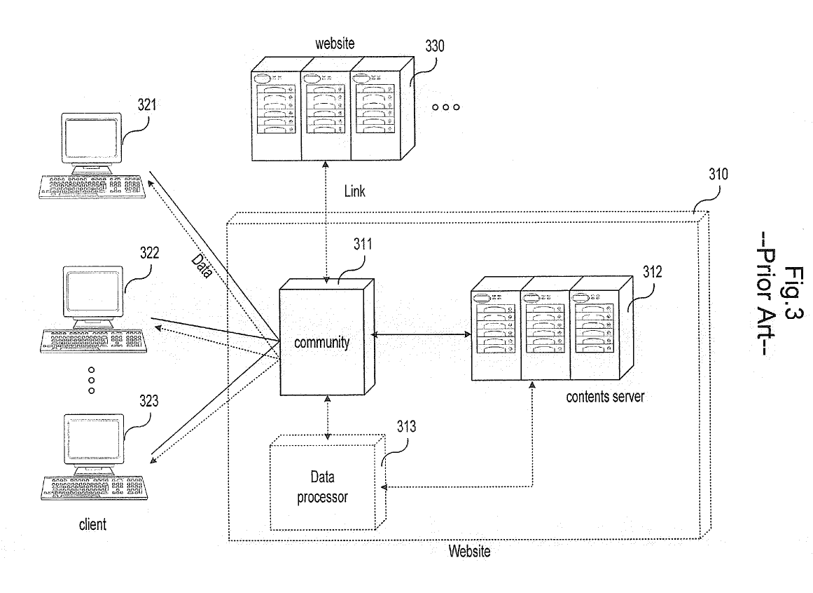

FIG. 3 is a diagram illustrating an example of a conventional website having a community and a contents server according to an embodiment of the present invention.

As shown in FIG. 3, a website 310 according to an embodiment of the present invention includes a community 311 to which a plurality of clients 321, 322, and 323 are interworked, and a contents server 312 providing a plurality of contents to the community 311. Here, the community 311 further includes a data processor 313 that can be implemented by a software program.

More specifically, when the plurality of clients 321, 322, and 323 access the community 311 and then execute a linked program, the community 311 receives in-formation on history or rank of the plurality of clients 321, 322, and 323, in relation to the multi-user game program, from a website 330 or the contents server 312 providing the multi-user game program, and then provides the information processed in a desired form of data by the data processor 313.

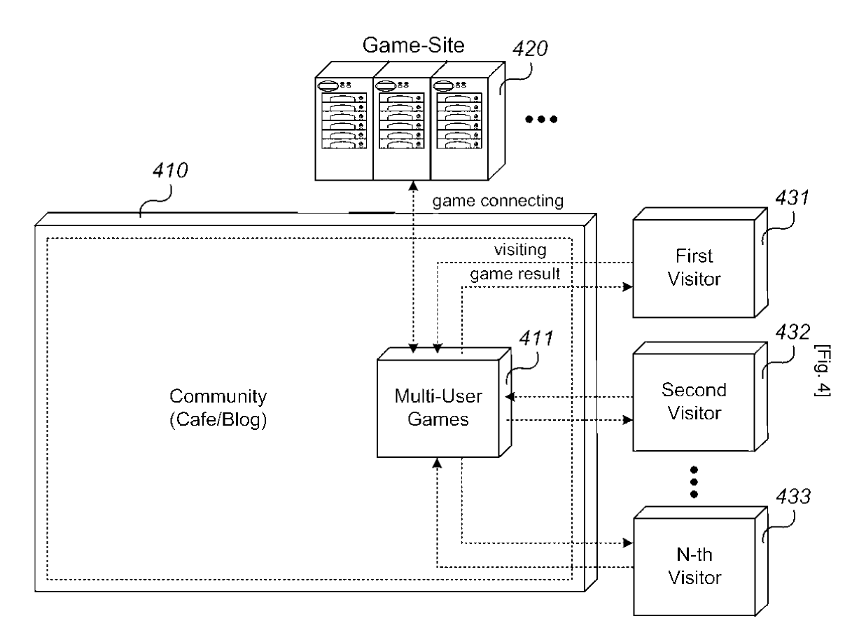

FIG. 4 is a diagram illustrating a multi-user game in a community according to an embodiment of the present invention.

Referring to FIG. 4, a multi-user game in a community according to an embodiment of the present invention is prepared as a type of game program, for example, a multi-user game 411 which is shared by a plurality of users, in a community 410 on a website, e.g., a blog or a cafe and can then be executed by a plurality of visitors 431, 432, and 433 who are visiting a current webpage.

Here, the multi-user game 411 is interworked to another game site 420 to be executed on the website, or it is downloaded from a contents server of a website to which the community belongs. A result is displayed which the plurality of visitors 431, 432, and 433 execute and obtain a multi-user game. Also, the multi-user game may comprise various games interworked to each game server, and it may be installed in a blog or a cafe selectively. Preferably, the multi-user game may be a multi-user flash game which is participated in by a plurality of users. Here, it is obvious to those skilled in the art that the multi-user game is not restricted to the flash game if it is at least a competitive game in which one or more participants can take part.

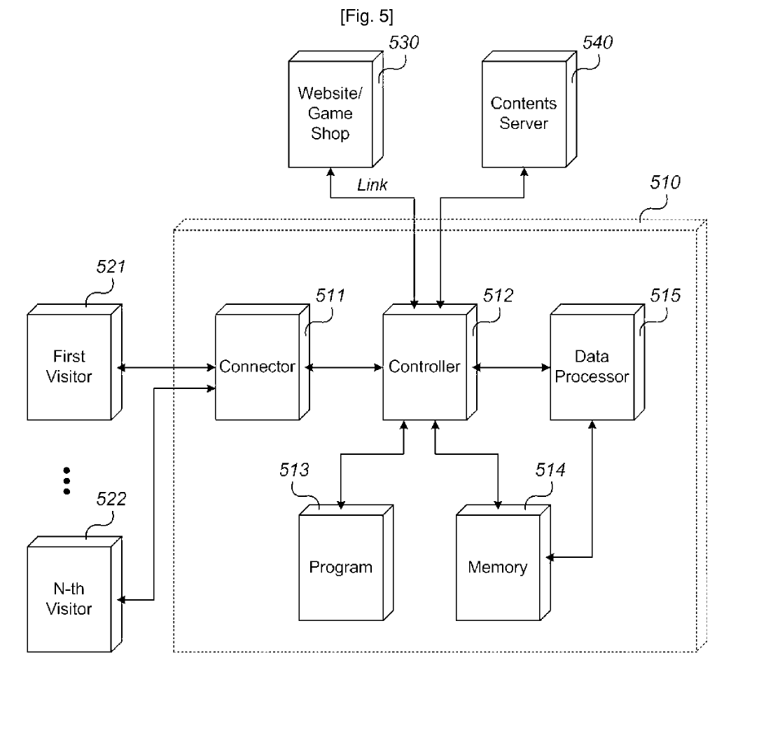

FIG. 5 is a schematic diagram illustrating a configuration of a multi-user game system in a community according to an embodiment of the present invention.

Referring to FIG. 5, a multi-user game system 510 in a community according to an embodiment of the present invention includes a connector 511, a multi-user game controller 512, an application program 513, a data storage unit 514, and a data processor 515.

The connector 511 determines whether or not a plurality of visitors 521, 522, and 523 are permitted to access the community. For example, the connector 511 may perform procedures related to subscription and authentication of the visitors 521, 522, and 523 according to operation methods of the community. In this case, the visitors 521, 522, and 523 may be a plurality of clients and the community may be cafe, homepages, blogs, mini-rooms, or mini-homepages that are established in websites on the Internet.

The connector 511 downloads pre-stored game information, and applies the pre-stored game information in the execution of the multi-user game. Here, the pre-stored game information may be ranking data or log data obtained by game participants. For example, data of the best user and the best score obtained in the multi-user game may be displayed. The controller 511 may utilize the pre-stored game information in the multi-user game which are downloaded from the contents server, although the pre-stored game information may be different according to the type of game.

The multi-user game controller 512 causes the visitors 521, 522, and 523 who have accessed the community to select one of multi-user game programs prepared in the community, and then receives visitor-related data from a website 530 providing the multi-user game program. Also, the multi-user game controller 512 causes the multi-user game program to be interworked to the plurality of visitors 521, 522, and 523 such that the plurality of visitors participate in the multi-user game program simultaneously. In this case, it is preferable that the multi-user game controller 512 keeps a resource occupation ratio of a system operated by the community at an appropriate level such that the resource occupation ratio does not exceed a prescribed rate.

In this case, the multi-user game program may be a program interworked to a contents server of a website to which the community belongs or a program interworked to another website, and the contents server can allow the multi-user game program to be executed on a web browser of the community.

The data processor 515 processes the visitor-related data such that the data can be utilized in the community, and the data storage unit 514 stores the processed visitor-related data. The processed visitor-related data can be updated whenever the multi-user game program is executed. In addition, the application program 513 may be a bulletin board, an editor, a visitor's book, or the like, which are required to operate the community.

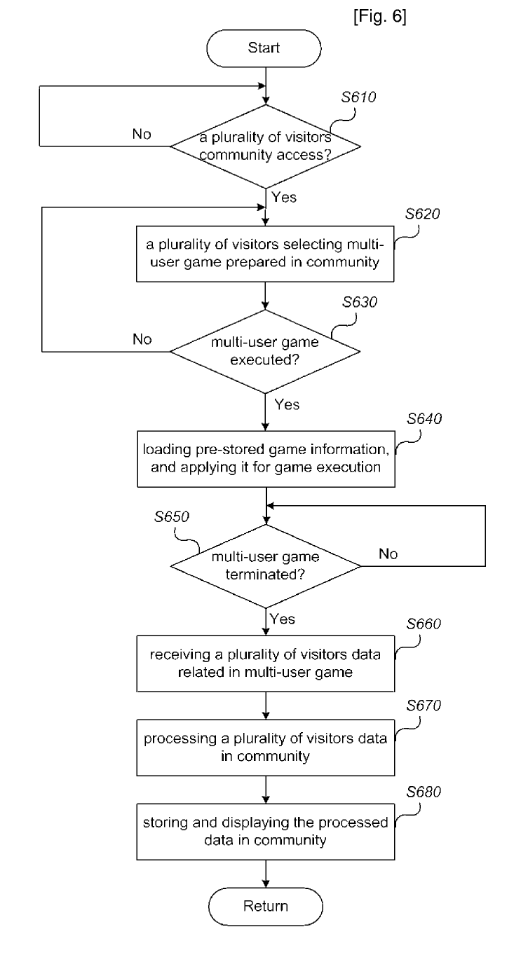

FIG. 6 is a flow chart illustrating a method for a multi-user game in a community according to an embodiment of the present invention.

Referring to FIG. 6, in the method for a multi-user game in the community according to the embodiment of the present invention, first, if the controller 511 permits a plurality of visitors to access the community which is a cafe, a homepage, a blog, a miniroom, or a mini-homepage established in a website on the Internet (S610), the multi-game controller 512 causes users to select one of multi-user game programs prepared in the community (S620). Here, the multi-user game program may be a program interworked to another website or may be a program interworked to a contents server of a website to which the community belongs.

In this case, the multi-user game program may be a flash game program which is a game item in which users can simply join on a website and from which the users can have amusement and pleasure. In other words, since a game machine in the community is supported for the purpose of formation of the sense of intimacy between individuals, visitors can understand rules of the game intuitively and join in the game.

Thereafter, the multi-user game controller 512 confirms whether or not the visitors are accessing the multi-user game program (S630) to execute the multi-game program.

Here, the multi-user game controller 512 downloads to apply pre-stored game in-formation when the multi-user game program is executed (S640). The pre-stored game information may be ranking information or log information.

Next, the multi-user game controller 512 confirms whether or not the multi-user game program is terminated by the plurality of visitors (S650).

Next, if the community visitors terminate the multi-user game program, the data controller 515 receives the visitor-related data related to the execution of the multi-user game program (S660), and then processes the received visitor-related data in the community (S670). Here, the visitor-related data may be game data, community use data, or data on a bonus, level, score, or rank obtained when the multi-user game program is executed and used. At this time, the visitor-related data may be provided in the form of a webpage at the time of terminating the multi-user game program. Also, the visitor-related data may be received by a type of data socket when the multi-user game program is executed.

In addition, the community visitors can acquire bonuses if they achieve a specific result when executing the above link program. For example, after community visitors access the community and execute and use the multi-user game program, bonuses such as a random drawing of persons who have a large score in the breaking of a record, random drawing of persons who win first place within a certain time period, hitting of a specific score, and the like, may be offered to the community visitors.

Thereafter, the multi-user game controller 512 stores and displays the processed visitor-related data in the community (S680), and the stored visitor-related data can be updated whenever community visitors execute and use the multi-user game program.

Here, the displaying or utilizing method data in the multi-user game can be varied according to forms of visitor-related data desired by the community, the amount of data storage space in the community, or performance of a system operated by the community.

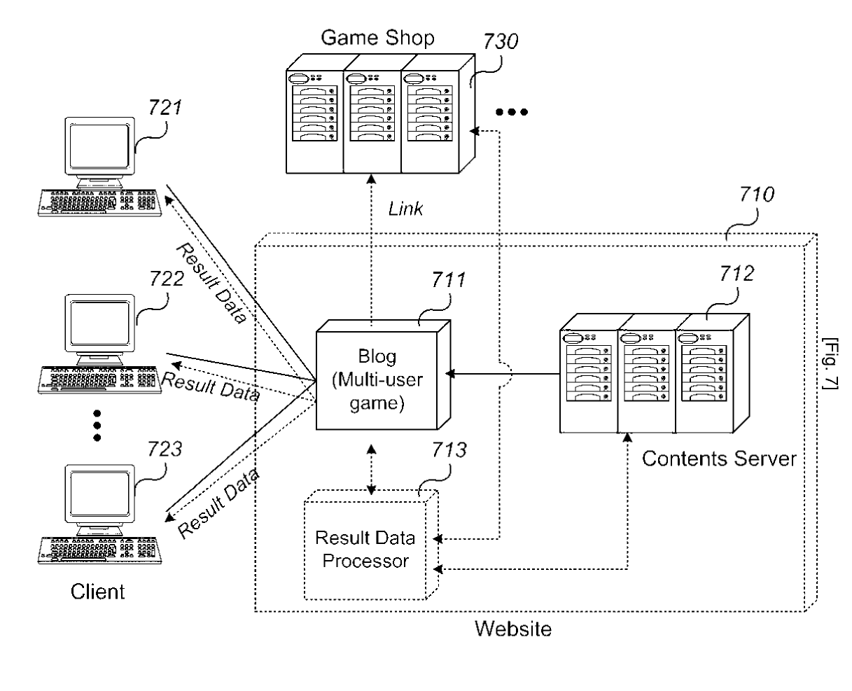

FIG. 7 is a diagram illustrating a method for a multi-user game in a flash game-linked blog according to an exemplary embodiment of the present invention, where a multi-user game in which a plurality of clients 721, 722, and 723 may take part can be executed in the case that the community on a website 710 is a blog 711.

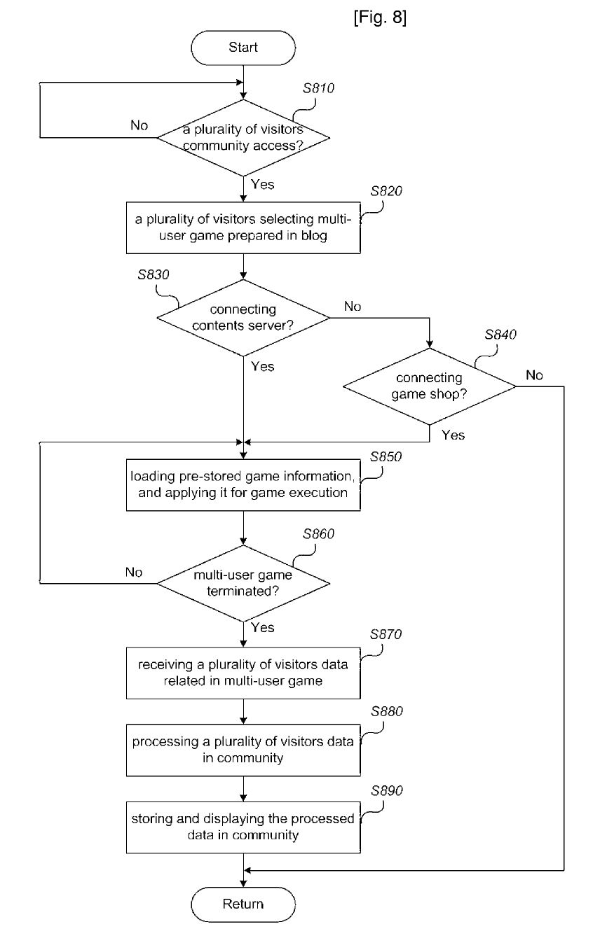

In a comparison of the method of FIG. 7 with that of FIG. 3, it can be seen in FIG. 7 that the data processor 313 of FIG. 3 is embodied as a ranking data processor 713, and the website 330 of FIG. 3 is embodied as a game shop 730. Now, the multi-user game method in the flash game-linked blog will be described with reference to FIG. 8.

FIG. 8 is a flow chart illustrating a method for a multi-user game in a flash game-linked blog according to an exemplary embodiment of the present invention.

Referring to FIG. 8, in the multi-user game method in the flash game-linked blog according to the exemplary embodiment of the present invention, first, the connector 511 permits the plurality of visitors to access a community, e.g., a blog (S810), and the multi-user game controller 512 then causes the visitors to select a multi-user flash game program prepared in the blog (S820). In other words, a multi-user flash game is used as post contents giving an amusement element to the visitor, and for example, a multimedia connection can be utilized in a way that a use link is connected or copied.

Next, if the blog visitors are interworked to a contents server in a website to which the blog belongs (S830) or interworked to the game shop (S840) in order to interwork to the multi-user flash game, the multi-user flash game is executed. Here, pre-stored game information are downloads to apply when the multi-user flash game is executed (S850). Accordingly, the download game information is displayed in the multi-user flash game or is utilized for the game progression.

Next, the multi-user game controller 512 confirms whether or not the multi-user flash game program is terminated (S860).

Next, when the execution of the multi-user flash game program is terminated, the data processor 515 receives the game data of the blog visitors obtained in the execution of the multi-user flash game program (S870), and then the data processor 515 processes the multi-user flash game data of the visitors as data, e.g., score or ranking data in the community (S880).

Thereafter, the processed data are stored and are displayed in the community (S890), and then the score and ranking data are updated if the visitors re-use the multi-user flash game program.

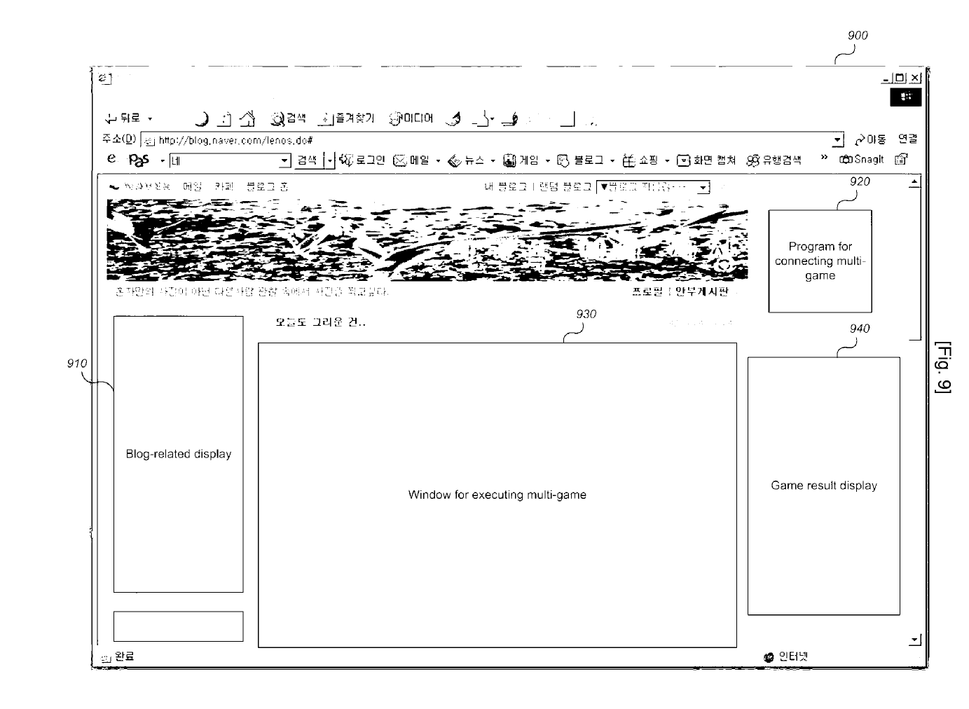

FIG. 9 is a diagram illustrating an example of a flash game linked blog in which a multi-user game is executed, according to an exemplary embodiment of the present invention, wherein a blog screen including a program for interworking to a multi-user game 920 is shown in the right upper portion of a blog 900 implemented in a website on the Internet. Here, the multi-user game is executed in a window for executing the multi-user game 930, and a result of the multi-user game is displayed in a game result display 940. In this figure, reference numeral 910 is a blog-related display which shows a profile of a blog operator, guide information for blog, and the like.

Pleasure through interaction with strangers in this blog is a basic desire, and as this desire is satisfied more, the degree of loyalty and participation for service further increases. Thus, networks in the blog can be expanded. Therefore, by utilizing contents shared in a community space, a sense of belonging, relationship, and friendship in the community is strengthened.

Although the exemplary embodiments of the present invention have been described in detail, it is obvious to those skilled in the art that the present invention is not restricted to the embodiments and may be modified or changed in various forms without deviating from the spirit and scope of the invention as set forth in the annexed claims.

### INDUSTRIAL APPLICABILITY

According to the present invention, community participation contents utilized as dynamic contents can attract participation of a large number of users.

According to the present invention, it is possible to provide services specialized by blog items and create customized services, and new contents can be provided easily as a multi-user game is basically loaded on a web browser.

What is claimed is

1. A multi-player game method in a community, the method comprising:
a) allowing access from a plurality of users to the community website;
b) receiving a signal from the user who accesses the community website and selects a multi-player game application;
c) executing the multi-player game application at the community website without linking to another website;
d) receiving user-related data in association with the execution of the multi-player game application; and
e) processing user-related data in the community website.

2. The method of claim 1, further comprising:
f) displaying the processed user-related data in the community.

3. The method of claim 1, wherein the step b) further comprises applying pre-stored game information when the multi-player game application is executed.

4. The method of claim 1, wherein the multi-player game application is a game program interworked to other websites.

5. The method of claim 1, wherein the multi-player game application is a program interworked to a contents server of the website to which the community belongs.

6. The method of claim 5, wherein the contents server causes the multi-player game application to be executed on a web browser of the community.

7. The method of claim 6, wherein the plurality of user-related data are data related to the multi-user game or data used in the community.

8. The method of claim 1, wherein the plurality of user-related data are at least one selected from a group consisting of items, levels, scores, and rank data obtained when the multi-player game application is executed.

9. The method of claim 1, wherein the stored user-related data are updated whenever a community user executes and uses the multi-player game application.

10. The method of claim 1, wherein the plurality of visitors acquire bonuses for the execution of the multi-player game application.

11. A system for multi-user game in a community, the system comprising:
a connecting module, the connecting module determining whether a community visitor is permitted to access the community website;
a multi-user game controller, the multi-user game controller allowing the community visitor to access the community to select a multi-user game program executed in the community without linking to another website and the multi-user game controller receiving visitor-related data from a website providing the multi-user game program;
a data processor, the data processor processing the visitor-related data such that the visitor-related data are utilized in the community; and
a data storage unit, the data storage unit storing the processed visitor-related data.

12. The system of claim 11, wherein the multi-user game controller causes the multi-user game program to be interworked to the plurality of visitors such that the plurality of visitors participate in the multi-user game program simultaneously.

13. The system of claim 11, wherein the multi-user game controller maintains a resource occupation ratio of a system operated by the community at an appropriate level such that the resource occupation ratio does not exceed a prescribed rate.

14. The system of claim 11, wherein the multi-user game program is a program interworked to a contents server of the website to which the community belongs or a program interworked to other websites.

15. The system of claim 11, wherein the contents server causes the multi-user game program to be executed on a web browser of the community.

16. The system of claim 11, wherein the connector provides pre-stored game information when the multi-user game program is executed.

17. (canceled)
